(19) United States
(12) Patent Application Publication
(10) Pub. No.: US 2022/0095602 A1
(43) Pub. Date: Mar. 31, 2022

(54) A PLUG ASSEMBLY

(71) Applicant: Termiplug Pty Ltd, Queensland (AU)

(72) Inventor: Russell Condon, Queensland (AU)

(21) Appl. No.: 17/424,063

(22) PCT Filed: Jan. 17, 2020
(86) PCT No.: PCT/AU2020/050022

§ 371 Date: Jul. 19, 2021

(30) Foreign Application Priority Data
Jan. 21, 2019 (AU) 2019100063
Jan. 21, 2019 (AU) 2019200387

(51) Int. Cl. A01M 1/20

(52) U.S. Cl. CPC A01M 1/2005

(57) ABSTRACT

A plug assembly having an insert having an aperture extending from a first end of the insert to a second end, the aperture defining a tapered female thread tapering from a larger diameter towards the first end to a smaller diameter towards the second end, and a plug having a head portion and a base portion, and a tapered male thread located between the head portion and the base portion, wherein the plug is adapted to screw into the insert to secure the plug in the insert.

### FIELD OF INVENTION

The present invention relates to a plug assembly. Reference will be made in the specification to the use of the invention with respect to inspection, prevention and/or treatment of insect infestation. The patent specification describes this use but it is by way of example only and the invention is not limited to this use.

### BACKGROUND OF THE INVENTION

Insect infestations can be very costly. For example, termite infestations in a building can cause sever damage requiring extensive reconstruction.

There are a number of different treatments for insects such as termites. Poisons can be sprayed against these types of insects. Additionally, or alternatively, these insects can be baited.

It is also important to be able to check for insect infestations before sever damage is caused. Such inspections can be conducted by visually inspecting for insects and insect activity. A problem with visual inspection is that this typically requires access to confined areas where insects might be present. A further problem is that visual inspection may require holes to be cut into walls, ceilings and floors.

One prior art method for inspecting for insects involves using a thermal imaging camera to detect heat generated by insects. Areas having a high heat signature can then be visually inspected for insect activity.

There are a number of suitable prior art solutions to the inspection, prevention and treatment of insect infestations.

### OBJECT OF THE INVENTION

It is an object of the present invention to overcome or at least alleviate one or more of the above mentioned problems with inspection, prevention and/or treatment of insect infestation, and/or provide the consumer with a useful or commercial choice.

### SUMMARY OF THE INVENTION

In one aspect, the present invention broadly resides in a plug assembly having
an insert having an aperture extending from a first end of the insert to a second end, the aperture defining a tapered female thread tapering from a larger diameter towards the first end to a smaller diameter towards the second end;
a plug having a head portion and a base portion, and a tapered male thread located between the head portion and the base portion;
wherein the plug is adapted to screw into the insert to secure the plug in the insert.

Preferably the insert includes a flange portion towards the first end. Preferably the flange portion is partially arcuate. Preferably the flange portion is flush with a part of the head portion of the plug when the plug is securely screwed into the insert. Preferably the insert includes one or more retaining ribs located on an external surface of the insert between the first end and the second end. Preferably the one or more retaining ribs are adapted to retain the insert in an aperture in a surface. Preferably the thread of the female thread is a rounded thread. The aperture of the insert is preferably sized between 5 mm to 30 mm. Preferably the insert is made from a plastic material. Preferably the insert is formed by injection moulding. Preferably the aperture further defines a shoulder portion which is adapted to abut a part of the head portion of the plug.

Preferably the plug includes an aperture extending from the base portion towards the head portion. Preferably the plug includes at least one opening extending between an external surface of the plug to the aperture. In another embodiment, the plug includes at least one opening extending between one side of the external surface to another side of the external surface of the plug. Preferably insect bait can be attached to the plug. More preferably insect bait can be attached to the plug via the at least one opening. Preferably in use, insect bait can be inserted into the insert prior to the plug being inserted into the insert.

Preferably the head portion of the plug is at least partially arcuate. Preferably the head portion includes a projection that partially projects from the arcuate part of the head portion. Preferably the projection can be turned using a tool that conforms to the arcuate portion of the head portion and the projection of the head portion.

Preferably a central part of the projection is substantially flush with the arcuate portion of the head portion. Preferably the projection is substantially rectangular in cross section. Preferably the arcuate portion of the plug is substantially dome shaped.

Preferably, when the plug is secured to the insert, the arcuate portion of the head portion is substantially flush with the arcuate portion of the flange portion of the insert. Preferably the arcuate portion of the head portion and the arcuate portion of the flange portion define a dome shape when the plug is secured to the insert.

The tapered male thread of the plug preferably tapers from a larger diameter towards the head portion to a smaller diameter towards the base portion. Preferably the thread of the tapered male thread is a rounded thread. It will be appreciated that a rounded thread refers to the shape of the thread and may have a radiused or curved surface compared to the straight surfaces of a V-shaped thread.

Preferably the plug is made from a plastic material. Preferably the plug is formed by injection moulding.

Preferably, the assembly further includes a tool having a shaped socket to accommodate the head portion of the plug. Preferably the socket conforms to the projection of the head portion. More preferably the socket conforms to the shape of the arcuate portion of the head portion as well as the projection of the head portion. Preferably, the socket conforms to a part of the flange portion of the insert. Preferably the tool includes a handle such that the tool can be manually rotated. In another embodiment, the tool can be attached to a drill or bit driver. Preferably, the central part of the projection being substantially flush with the arcuate portion of the head portion prevents the plug being easily removed from the insert without the tool.

Preferably the tool is made from a plastic material. Preferably the tool is formed by injection moulding.

In another aspect, the present invention broadly resides in a plug assembly having
an insert having an aperture extending from a first end of the insert to a second end, the aperture defining a female thread located between the first end and the second end;
a plug having a head portion and a base portion, and a male thread located between the head portion and the base portion, the head portion having an arcuate portion and a projection;
wherein a central portion of the projection is substantially flush with the arcuate portion of the head portion, and wherein the plug is adapted to screw into the insert to secure the plug in the insert.

Preferably the female thread is a tapered female thread tapering from a larger diameter towards the first end to a smaller diameter towards the second end.

Preferably the male thread is a tapered male thread located between the head portion and the base portion. The tapered male thread of the plug preferably tapers from a larger diameter towards the head portion to a smaller diameter towards the base portion.

Preferably the plug assembly is an insect inspection plug assembly. More preferably the plug assembly is a termite inspection plug assembly. Preferably the plug assembly is a termite bait plug assembly. Preferably the plug assembly is an insect bait plug assembly.

Preferably the insert is shaped to allow an inspection camera to see behind the surface that the insert is located in. Preferably the inspection camera is a fibre optic camera. Preferably the inspection camera can be inserted into the aperture in the insert when the plug is removed. Preferably the aperture of the insert is shaped to allow insecticide to be sprayed through the aperture and behind the surface that the insert is located in.

In a further aspect, the present invention broadly resides in a plug for a plug assembly, the plug having
a head portion having an arcuate portion and a projection;
a base portion; and
a thread located between the head portion and the base portion,
wherein a central portion of the projection is substantially flush with the arcuate portion of the head portion.

Preferably the male thread is a tapered male thread located between the head portion and the base portion. The tapered male thread of the plug preferably tapers from a larger diameter towards the head portion to a smaller diameter towards the base portion.

In another aspect, the present invention broadly resides in a plug assembly kit having
a plurality of inserts, each insert having an aperture extending from a first end of the insert to a second end, the aperture defining a female thread located between the first end and the second end;
a plurality of plugs, each plug having a head portion and a base portion, and a male thread located between the head portion and the base portion, the head portion having an arcuate portion and a projection; and
a tool having a shaped socket to accommodate the head portion of the plug;
wherein a central portion of the projection is substantially flush with the arcuate portion of the head portion, and wherein the tool is adapted to screw each plug into a corresponding one of the plurality of inserts to secure the plug in the insert.

In a further aspect, the present invention broadly resides in an insert for a plug assembly, the insert having
an aperture extending from a first end of the insert to a second end, the aperture defining a tapered female thread tapering from a larger diameter towards the first end to a smaller diameter towards the second end; and
a flange portion towards the first end, the flange portion being partially arcuate;
wherein the thread of the female thread is a rounded thread.

In one embodiment, the plug assembly is a termite plug assembly. Preferably the termite plug assembly is used for inspecting for termites, administering insecticide and/or applying termite bait.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a side view of a plug assembly according to an embodiment of the present invention;

FIG. 2 is a front view of the plug assembly of FIG. 1;

FIG. 3 is a bottom view of the plug assembly of FIG. 1

FIG. 4 is a sectioned view of the plug assembly if FIG. 1 along line A-A;

FIG. 5 is a view of detail A of FIG. 4;

FIG. 6 is a perspective view of the plug assembly of FIG. 1;

FIG. 7 is a side view of the insert of the plug assembly of FIG. 1;

FIG. 8 is a top view of the insert of FIG. 7:

FIG. 9 is a sectioned view of the insert of FIG. 7;

FIG. 10 is a perspective view of the insert of FIG. 7;

FIG. 11 is a side view of the plug of the plug assembly of FIG. 1;

FIG. 12 is a sectioned view of the plug of FIG. 11;

FIG. 13 is a top view of the plug of FIG. 11;

FIG. 14 is a bottom view of the plug of FIG. 11;

FIG. 15 is a top perspective view of the plug of FIG. 11; and

FIG. 16 is a bottom perspective view of the plug of FIG. 11.

### DETAILED DESCRIPTION OF THE PREFERRED EMBODIMENT

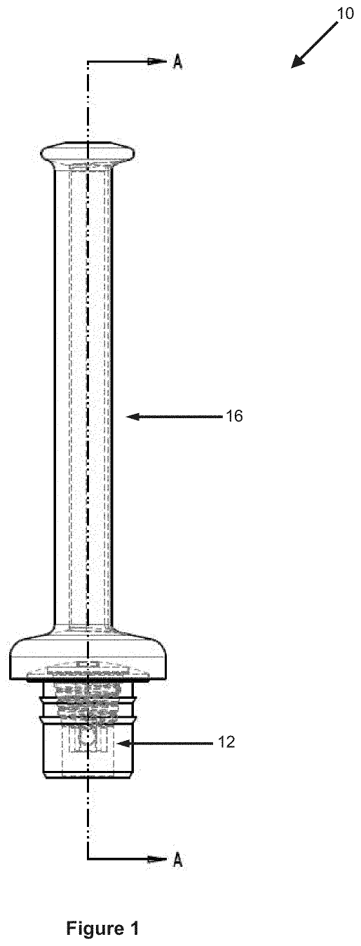

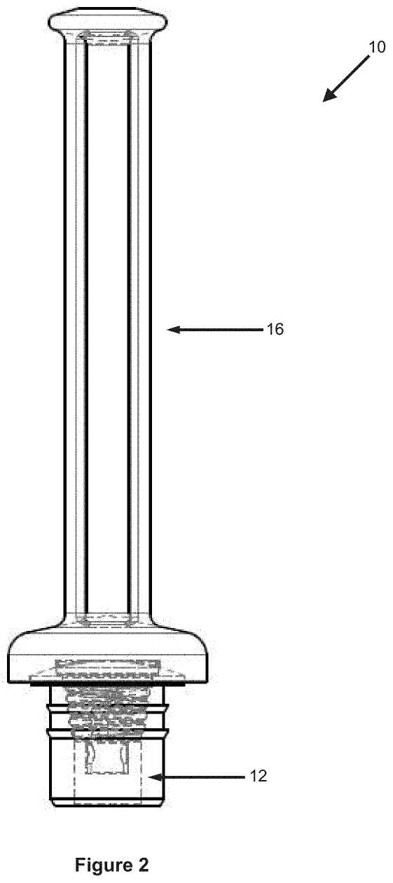

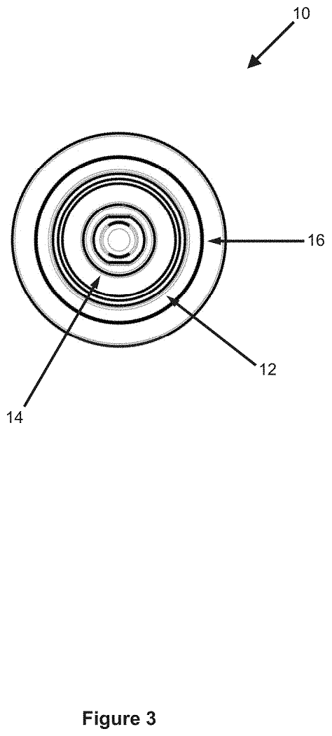

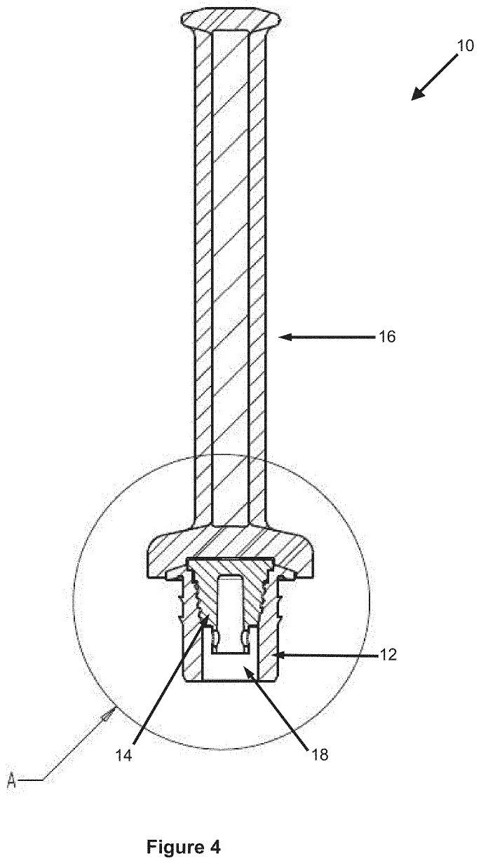

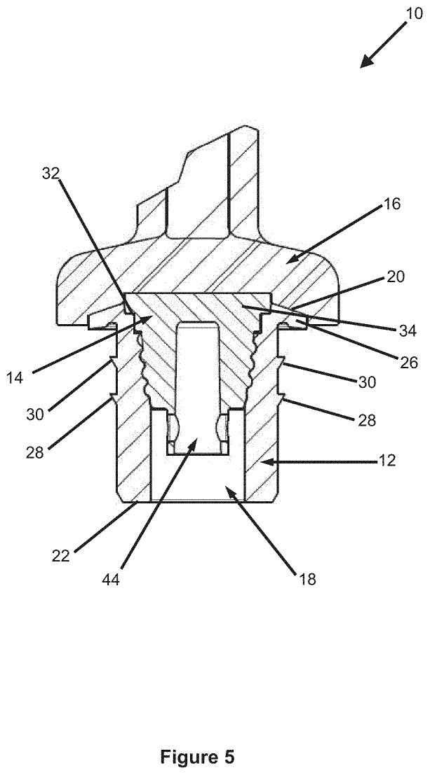

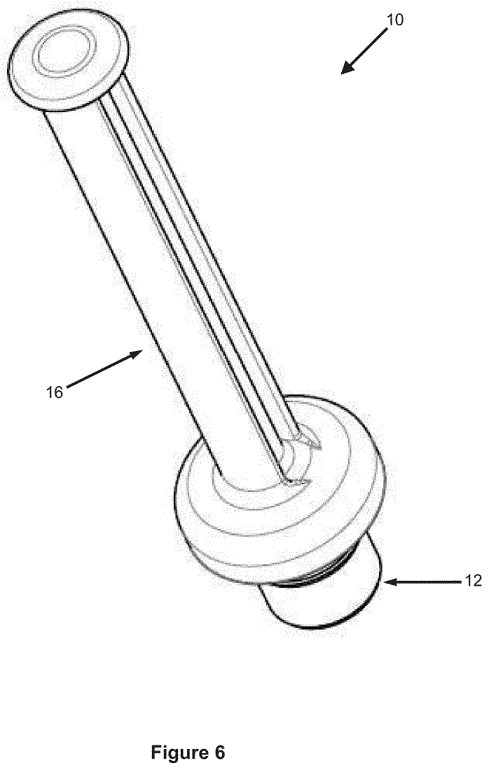

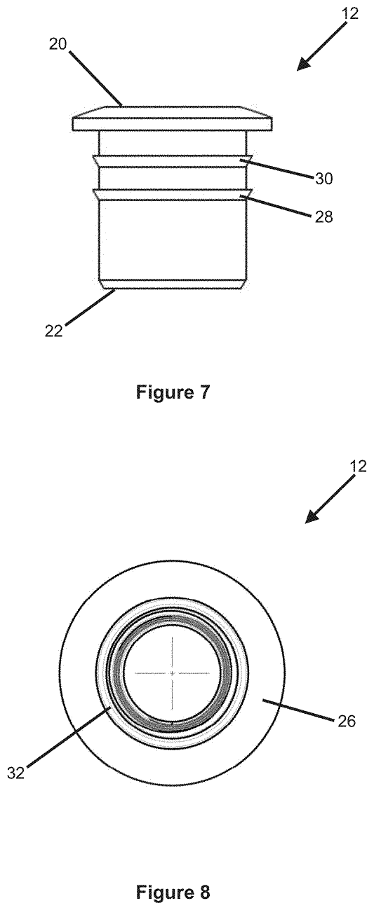

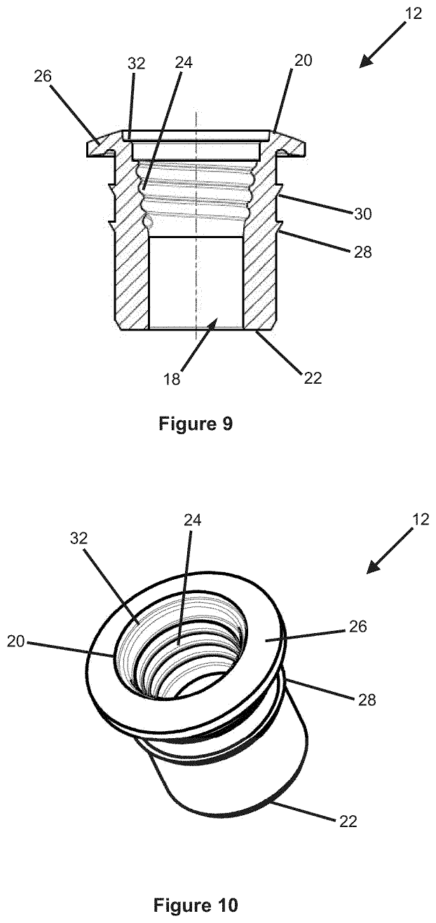

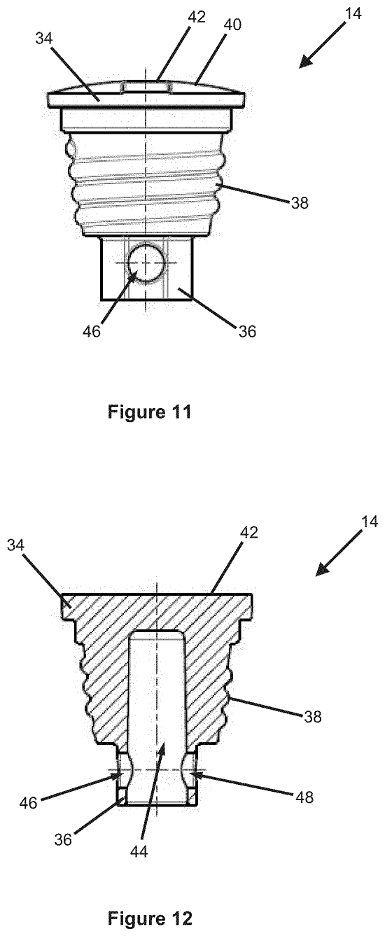

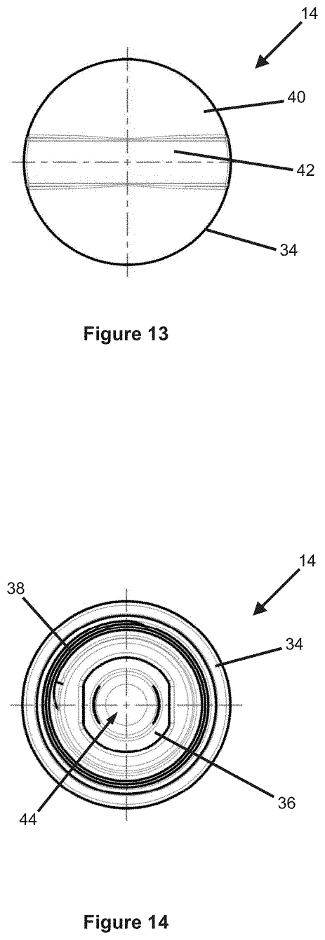

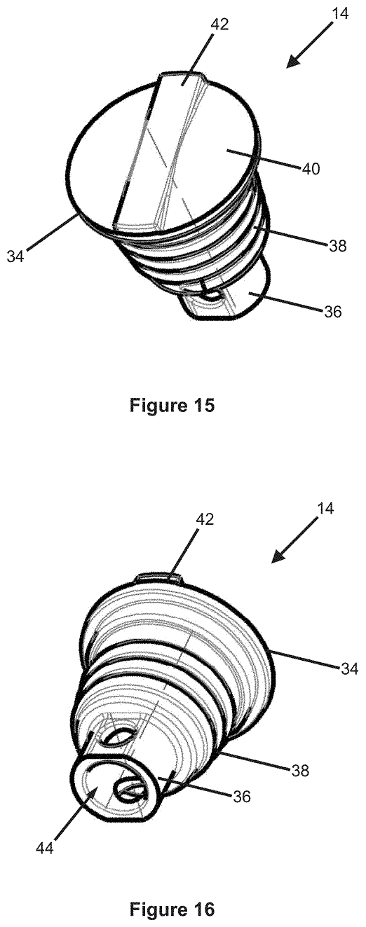

With reference to FIGS. 1-6 there is shown a plug assembly 10 according to an embodiment of the present invention. The plug assembly has an insert 12, a plug 14 and a tool 16. FIGS. 7-10 shown the insert 12 in more detail. FIGS. 11-16 shown the plug 14 in more detail.

The insert 12 is substantially round in shape. The insert 12 has an aperture 18 that extends from a first end 20 of the insert 12 to a second end 22 of the insert 12. The aperture 18 is substantially circular in cross section. The aperture 18 defines a female thread 24. The female thread 24 is tapered, tapering from a larger diameter towards the first end 20 to a smaller diameter towards the second end 22. The female thread 24 has a rounded shape. Having a rounded shaped and tapered female thread 24 assists in the removal of the insert 12 from an injection mould (not shown) without requiring the insert 12 to be rotated, as the insert 12 can deform slightly when made of plastic.

The insert 12 has a flange portion 26 towards the first end 20. The flange portion 26 is at least partially arcuate on a top surface thereof.

The insert has one or more retaining ribs in the form of retaining ribs 28,30 located on an external surface of the insert 12 between the first end 20 and the second end 22. The retaining ribs 28,30 assist in retaining the insert in a hole in a surface (not shown).

The insert 12 has a shoulder portion 32 defined by the aperture 18, the shoulder portion will be explained in more detail below with respect to the plug 14.

The plug 14 has a head portion 34 and a base portion 36. A male thread 38 is located between the head portion 34 and the base portion 36. The male thread 38 is tapered, tapering from a larger diameter towards the head portion 34 to a smaller diameter towards the base portion 34. The male thread 38 has a rounded shape. The rounded male thread 38 is adapted to engage with the rounded female thread 24 of the insert 12.

The head portion 34 has an arcuate portion 40 and a projection 42. A central portion of the projection 42 is substantially flush with the arcuate portion 40 of the head portion 34. Having the central portion of the projection 42 substantially flush with the arcuate portion 40 makes it difficult to use a non specialised tool (not shown, for example an adjustable wrench) or fingers to unscrew the plug 14 from the insert 12.

The plug 14 has an aperture 44 that extends from the base portion 36 towards the head portion 34. At least one opening in the form of openings 46,48 extend from an external surface of the plug 14 to the aperture 44.

The head portion 34 of the plug 14 is adapted to fit partially into the aperture 18 of the insert 12 such that a lower portion of the head portion 34 abuts the shoulder portion 32 of the insert 12. When the plug 14 is secured to the insert 12, the arcuate part of the flange portion 26 is flush with the arcuate portion 40 of the head portion 34.

In use, the insert 12 is inserted into a hole drilled into a surface (not shown) such as a window sill, a wall, a floor or a surface inside a cupboard. The retaining ribs 28,30 retain the insert 12 in the surface. The insert 12 provides access to behind the surface so that an inspection camera (not shown) can be inserted into the aperture 18 to check the space behind the surface, so that the space behind the surface can be sprayed with insecticide, and so that insect baits can be placed in the space behind the surface. Insect bait (not shown) can be secured to the plug 14 via openings 46,48 and the aperture 44. Securing the plug 14 to the insert 12 with the tool 16 prevents access to the space and potentially poisonous insecticide and baits by children. The arcuate portion 40 of the head portion 34 and the projection 42 also prevent children from being able to unscrew the plug 14 from the insert 12 without the use of the tool 16.

### ADVANTAGES

An advantage of the preferred embodiment of the plug assembly includes the tapered and rounded threads, which aid in the removal of the parts from an injection mould. Another advantage of the preferred embodiment of the plug assembly includes the arcuate head portion with the projection, this prevents easy removal of the plug from the insert without a specialised tool. A further advantage of the preferred embodiment of the plug assembly includes the tool fitting over the flange portion of the insert, this aids in locating the tool over the head portion. Another advantage of the preferred embodiment of the plug assembly is that spaces can be periodically checked for insect activity, insecticide can be re-applied and insect baits can be checked and replaced.

### VARIATIONS

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A plug assembly having
an insert having an aperture extending from a first end of the insert to a second end, the aperture defining a tapered female thread tapering from a larger diameter towards the first end to a smaller diameter towards the second end; and
a plug having a head portion and a base portion, and a tapered male thread located between the head portion and the base portion;
wherein the plug is adapted to screw into the insert to secure the plug in the insert.

2. A plug assembly having
an insert having an aperture extending from a first end of the insert to a second end, the aperture defining a female thread located between the first end and the second end; and
a plug having a head portion and a base portion, and a male thread located between the head portion and the base portion, the head portion having an arcuate portion and a projection;
wherein a central portion of the projection is substantially flush with the arcuate portion of the head portion, and wherein the plug is adapted to screw into the insert to secure the plug in the insert.

3. A plug assembly as claimed in claim 1, wherein the thread of the female thread is a rounded thread, and the thread of the male thread is a rounded thread.

4. A plug assembly as claimed in claim 1 wherein the head portion of the plug has an arcuate portion and a projection, and wherein a central portion of the projection is substantially flush with the arcuate portion of the head portion.

5. A plug assembly as claimed in claim 1, wherein the insert includes a flange portion towards the first end.

6. A plug assembly as claimed in claim 5, wherein the flange portion is partially arcuate.

7. A plug assembly as claimed in claim 5, wherein the flange portion is flush with a part of the head portion of the plug when the plug is securely screwed into the insert.

8. A plug assembly as claimed in claim 1, wherein the insert includes one or more retaining ribs located on an external surface of the insert between the first end and the second end, the one or more retaining ribs adapted to retain the insert in an aperture in a surface.

9. A plug assembly as claimed in claim 1, wherein the plug includes an aperture extending from the base portion towards the head portion.

10. A plug assembly as claimed in claim 9, wherein the plug includes at least one opening extending between an external surface of the plug to the aperture of the plug.

11. A plug assembly as claimed in claim 1, wherein insect bait can be attached to the plug.

12. A plug assembly as claimed in claim 11, wherein in use, the insect bait is inserted into the insert prior to the plug being inserted into the insert.

13. A plug assembly as claimed in claim 6, wherein the arcuate portion of the head portion and the arcuate portion of the flange portion define a dome shape when the plug is secured to the insert.

14. A plug assembly as claimed in claim 1 further including a tool having a shaped socket to accommodate the head portion of the plug.

15. A plug assembly as claimed in claim 1, wherein the insert and the plug is made from a plastic material.

16. A plug assembly as claimed in claim 1, wherein the plug assembly is a termite plug assembly used for inspecting for termites, administering insecticide and/or applying termite bait.

17. A plug for a plug assembly, the plug having
a head portion having an arcuate portion and a projection;
a base portion; and
a thread located between the head portion and the base portion,
wherein a central portion of the projection is substantially flush with the arcuate portion of the head portion, and the thread is a tapered male thread and is a rounded thread.

18. A plug as claimed in claim 17, wherein the male thread is a tapered male thread located between the head portion and the base portion, the tapered male thread of the plug tapering from a larger diameter towards the head portion to a smaller diameter towards the base portion.

19. A plug assembly kit having
a plurality of inserts, each insert having an aperture extending from a first end of the insert to a second end, the aperture defining a female thread located between the first end and the second end;
a plurality of plugs, each plug having a head portion and a base portion, and a male thread located between the head portion and the base portion, the head portion having an arcuate portion and a projection; and
a tool having a shaped socket to accommodate the head portion of the plug;
wherein a central portion of the projection is substantially flush with the arcuate portion of the head portion, and wherein the tool is adapted to screw each plug into a corresponding one of the plurality of inserts to secure the plug in the insert.

20. An insert for a plug assembly, the insert having
an aperture extending from a first end of the insert to a second end, the aperture defining a tapered female thread tapering from a larger diameter towards the first end to a smaller diameter towards the second end; and
a flange portion towards the first end, the flange portion being partially arcuate;
wherein the thread of the female thread is a rounded thread.
